(19) United States
(12) Patent Application Publication
(10) Pub. No.: US 2026/0308491 A1
(43) Pub. Date: Oct. 8, 2026

(54) CLEANING AND DISINFECTING WIPES WITH ENHANCED THICKNESS PERCEPTION

(71) Applicant: The Clorox Company, Oakland, CA (US)

(72) Inventors: Edward Jason White, Plesasanton, CA (US); Nikhil P. Dani, Pleasanton, CA (US); Timothy Audiss, Pleasanton, CA (US); Kelly Dickson, Pleasanton, CA (US); Andrew Leppla, Elm Grove, WI (US); Daniela N. Fritter, Pleasanton, CA (US); Dawn Chapman, Pleasanton, CA (US)

(21) Appl. No.: 19/560,714

(22) Filed: Mar. 9, 2026

Related U.S. Application Data
(60) Provisional application No. 63/785,290, filed on Apr. 8, 2025.

(51) Int. Cl. C11D 17/04; C11D 1/00; C11D 3/39; D04H 1/26; D04H 1/4326

(52) U.S. Cl. CPC C11D 17/049; C11D 1/00; C11D 3/3927; D04H 1/26; D04H 1/4326

(57) ABSTRACT

A cleaning, sanitizing or disinfecting wipe comprising a nonwoven substrate comprising a combination of (i) polypropylene and/or other synthetic binder fibers and (ii) natural fibers, and a composition loaded onto said nonwoven substrate. The polypropylene and/or other synthetic binder fibers comprise an opacifier such as TiO₂ (e.g., the TiO₂ is mixed into the resin from which the polypropylene and/or other synthetic binder fibers are formed). The wipe has a “true thickness” value of greater than 5000, wherein true thickness is defined as (i) the basis weight (in gsm) of the nonwoven substrate times (ii) the reciprocal of mean hole area (in percent) times (iii) the total visual density times (iv) the TS750 texture rating of the nonwoven substrate, where total visual density is defined as percentage of TiO₂ or other opacifier included in the synthetic fibers (in percent) times the percentage of the nonwoven substrate fibers that are synthetic.

### CROSS REFERENCE TO RELATED APPLICATIONS

The present application claims the benefit of U.S. Patent Application Ser. No. 63/785,290 filed on Apr. 8, 2025, and entitled “CLEANING AND DISINFECTING WIPES WITH ENHANCED THICKNESS PERCEPTION,” which application is expressly incorporated herein by reference in its entirety.

### BACKGROUND OF THE INVENTION

### 1. The Field of the Invention

The present invention relates to cleaning wipes, e.g., pre-loaded cleaning wipes that are formed from single or multi-layer substrates, and which are pre-loaded during manufacture with a cleaning composition. Such pre-loaded wipes may be provided within a container (e.g., packaged therein during manufacture).

### 2. Description of Related Art

Numerous cleaning wipes are available, e.g., such as CLOROX DISINFECTING WIPES. While such wipes provide good overall cleaning and disinfection characteristics, versatility, and convenience, there is a continuing need for improved cleaning wipes.

For example, perception of optimal thickness is an important driver of consumer satisfaction and performance in cleaning and disinfecting wipes. Traditional methods to impart thickness include adding mass, increasing fiber packing density, adding texture, and the like. While such methods may be effective on some level they are often expensive, and do not necessarily capture true human user experience and/or consumer perception or experience relative to wipe thickness, especially for wipes that include natural fibers such as wood pulp.

It would be an advantage to provide a cleaning, disinfecting or sanitizing wipe that could provide improved perception of thickness in the experience of the human user experience and/or consumer. It would be a further advantage if such could be accomplished with minimal or no increase in costs, or complexity of manufacture.

### BRIEF SUMMARY

An embodiment of the present disclosure is directed to a cleaning, sanitizing or disinfecting wipe comprising: (i) a nonwoven substrate comprising a combination of polypropylene or other synthetic binder fibers and natural fibers; and (ii) a cleaning, sanitizing or disinfecting composition loaded onto the nonwoven substrate. The cleaning, sanitizing or disinfecting composition may include at least a surfactant and water. The composition may comprise at least about 70% by weight of water. The nonwoven substrate has a “true thickness” value of greater than about 5000.

Another embodiment of the present disclosure is directed to a sanitizing or disinfecting wipe comprising: (i) a nonwoven substrate comprising a combination of polypropylene or other synthetic binder fibers and natural fibers, wherein the polypropylene or other synthetic binder fibers comprise at least about 30% by weight of overall nonwoven substrate fibers of the nonwoven substrate, wherein the polypropylene or other synthetic binder fibers comprise TiO₂ or another opacifier; and (ii) a sanitizing or disinfecting composition loaded onto said nonwoven substrate. The sanitizing or disinfecting composition comprises a sanitizing or disinfecting agent (e.g., at least one of a quaternary ammonium compound, a sanitizing or disinfecting organic acid, and/or peroxide or a peracid compound), a surfactant and water. The composition may comprise at least about 90% by weight of water. The nonwoven substrate has a “true thickness” value of greater than 5000.

True thickness can be defined as (i) basis weight (in gsm) of the nonwoven substrate times (ii) a reciprocal of mean hole area (in percent) times (iii) total visual density times (iv) a TS750 texture rating of the nonwoven substrate. Total visual density can be defined as percentage of TiO₂ included in the polypropylene fibers (in percent) times a percentage of the overall nonwoven substrate fibers that are polypropylene fibers. Stated another way, total visual density can be defined as the percentage of TiO₂ included in the polypropylene fibers (in percent) times a quotient of the basis weight of the polypropylene fibers (in gsm) relative to (i.e., divided by) the basis weight of the nonwoven substrate as a whole (in gsm).

In any of the described embodiments, the polypropylene fibers may include more than 0.5% TiO₂ or other opacifier by weight.

In any of the described embodiments, the polypropylene fibers may include at least about 1% TiO₂ or other opacifier by weight.

In any of the described embodiments, the polypropylene fibers may include from about 0.5% to about 5% TiO₂ or other opacifier by weight.

In any of the described embodiments, the polypropylene fibers may include from about 0.6% to about 5% TiO₂ or other opacifier by weight.

In any of the described embodiments, the polypropylene fibers may include from about 0.8% to about 2% TiO₂ or other opacifier by weight.

In any of the described embodiments, the natural fibers may comprise pulp fibers (e.g., wood pulp).

In any of the described embodiments, the nonwoven substrate may have an overall basis weight of from about 20 gsm to about 80 gsm.

In any of the described embodiments, the nonwoven substrate may be substantially void of biodegradable or compostable (and expensive) polyesters such as PLA, PHA, PBAT and the like.

In any of the described embodiments, the polypropylene or other synthetic binder fibers (e.g., polyester such as PET) may comprise at least 35% by weight of the overall fibers included in the nonwoven substrate.

In any of the described embodiments, the polypropylene or other synthetic binder fibers may comprise from about 35% to about 70% by weight of the overall fibers included in the nonwoven substrate.

In any of the described embodiments, the natural fibers may comprise at least about 30% by weight of the overall fibers included in the nonwoven substrate.

In any of the described embodiments, the natural fibers may comprise from about 30% to about 65% by weight of the overall fibers included in the nonwoven substrate.

In any of the described embodiments, the composition may further comprise a quaternary ammonium compound, a sanitizing or disinfecting organic acid (e.g., citric acid, lactic acid, or other), or other sanitizing or disinfecting agent.

In any of the described embodiments, the composition may comprise at least 90%, at least 95%, at least 97%, at least 98%, or at least 99% by weight water.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIG. 1 is a graphical illustration of how true thickness varies with basis weight.

FIG. 2 is a graphical illustration of how predicted thickness varies with basis weight.

FIG. 3 is a graphical illustration of how human perception of thickness varies with basis weight.

FIG. 4 is a graphical illustration of how true thickness varies with TiO₂ percentage in the polypropylene fibers.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

As used herein, the term “between” is inclusive of any endpoints noted relative to a described range.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

As used herein, “disposable” is used in its ordinary sense to mean an article that is disposed or discarded after a limited number of usage events, preferably less than 25, more preferably less than about 10, and most preferably after a single usage event. The wipes disclosed herein are typically disposable.

As used herein, the term “substrate” is intended to include any material that is used to clean an article or a surface. Examples of cleaning substrates include, but are not limited to, wipes, mitts, pads, or a single sheet of material which is used to clean a surface by hand or a sheet of material which can be attached to a cleaning implement, such as a floor mop, handle, or a handheld cleaning tool, such as a toilet cleaning device. The term “substrate” is also intended to include any material that is used for personal cleansing applications. These substrates can be used for hard surface, soft surface, and personal care applications. Such substrates may typically be in the form of a wipe.

Such substrates may be formed of a structure of individual fibers which are interlaid, typically in a manner that is not identifiable (e.g., a nonwoven). The nonwoven substrates, or layers used to make up such a nonwoven substrate included in the present substrates may be formed by any suitable process. For example, they may be meltblown, spunbond, spunlaid, SMS (spunbond-meltblown-spunbond), coformed, carded webs, thermal bonded, thermoformed, spunlace, hydroentangled, hydroembossed, needled, or chemically bonded. Various processes for forming such nonwovens will be apparent to those of skill in the art, many of which are described in U.S. Pat. No. 7,696,109, incorporated herein by reference in its entirety. EP Applications EP992338, EP1687136, EP1861529, EP1303661, and US2004/0157524 are also herein incorporated by reference, each in its entirety.

The terms “wipe”, “substrate” and the like may thus overlap in meaning, and while “wipe” may typically be used herein for convenience, it will be appreciated that this term may often be interchangeable with “substrate”.

As used herein, “wiping” refers to any shearing action that the wipe undergoes while in contact with a target surface. This includes hand or body motion, substrate-implement motion over a surface, or any perturbation of the substrate via energy sources such as ultrasound, mechanical vibration, electromagnetism, and so forth.

The cleaning compositions dosed onto the substrate as described herein may provide sanitization, disinfection, sterilization, other cleaning, or other treatment. As used herein, the term “sanitize” shall mean the reduction of “target” contaminants in the inanimate environment to levels considered safe according to public health ordinance, or that reduces a “target” bacterial population by significant numbers where public health requirements have not been established. By way of example, an at least 99% reduction in bacterial population within a 24 hour time period is deemed “significant.” Greater levels of reduction (e.g., 99.9%, 99.99%, etc.) are possible, as are faster treatment times (e.g., within 10 minutes, within 5 minutes, within 4 minutes, within 3 minutes, within 2 minutes, within 1 minute, or within 30 seconds), when sanitizing or disinfecting.

As used herein, the term “disinfect” shall mean the elimination of many or all “target” pathogenic microorganisms on surfaces with the exception of bacterial endospores.

As used herein, the term “sterilize” shall mean the complete elimination or destruction of all forms of “target” microbial life and which is authorized under the applicable regulatory laws to make legal claims as a “sterilant” or to have sterilizing properties or qualities.

Some embodiments may provide for at least a 2 or more log reduction (e.g., 3-log reduction, 4-log reduction, 5-log reduction, or 6-log reduction) in a bacterial population within a designated time period (e.g., 10 minutes, 5 minutes, 4 minutes, 3 minutes, 2 minutes, 1 minute, 30 seconds, or the like). A 2-log reduction is equivalent to a 99% reduction, a 3-log reduction is equivalent to at least a 99.9% reduction, a 4-log reduction is equivalent to at least a 99.99% reduction, a 5-log reduction is equivalent to at least a 99.999% reduction, etc. An example of a target microbe may be Staphylococcus aureus. It will be appreciated that antimicrobial efficacy can also be achieved against other target microbes, numerous examples of which will be apparent to those of skill in the art. It will also be appreciated that the present cleaning compositions need not include an antimicrobial agent (e.g., a quaternary ammonium compound or the like), where sanitization or disinfection is not necessarily desired.

In reference to various standardized tests (e.g., ASTM or other tests), it will be understood that reference to any such standard refers to the latest update (if any) of such standard, unless otherwise indicated. Any such referenced standards are incorporated herein by reference, in their entirety.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. Introduction

In an aspect, the present disclosure relates to systems and methods for enhancing the perception of thickness in cleaning and disinfecting wipes. In other words, such wipes are perceived as being thicker than comparative wipes. The present disclosure introduces a novel measure called “True Thickness” (TT), which combines multiple measurable attributes to better describe thickness perception. The TT formula considers both the felt and seen aspects of the wipe and incorporates basis weight, inverse (i.e., reciprocal) of mean hole area, total visual density, and texture rating. A TT value greater than 5000 has been found by applicant to be advantageous for wipes containing polypropylene (PP) or other synthetic binder fibers and natural fibers, such as pulp fibers. The TT formula, and providing a TT value of greater than 5000 provides an accurate and cost-effective way to enhance consumer satisfaction with such wipes.

### III. Exemplary Nonwoven Substrates

In an aspect, the present disclosure is directed to pre-loaded nonwoven substrates. The fibers and/or nonwoven may be formed by any suitable technique, e.g., including but not limited to meltblown, spunbond, spunlaid, SMS (spunbond-meltblown-spunbond), coform, carded webs, thermal bonded, thermoformed, spunlace, hydroentangled, hydroembossed, needled, or chemically bonded, and any combinations thereof.

In one embodiment, the nonwoven substrate may be comprised of multiple layers (e.g., 2 or 3 layers). In another embodiment, the substrate may be formed from a single layer. Where different layers are present, the initially separate layers may be bonded to one another through any of various suitable techniques that will be apparent to those of skill in the art. For example, hydroentangling, needling, thermal bonding, or any other technique may be used to bond such layers to one another.

No matter the process by which the dry nonwoven substrate is formed, once formed, a desired cleaning composition may be loaded onto the nonwoven substrate.

Various pulp or cellulose materials, or their derivatives may be particularly suitable for use in the present nonwoven substrates, because they are renewably sourced, and for other desired benefits. In an embodiment, polypropylene binder fibers are included in the nonwoven substrate. While polypropylene fibers may be particularly suitable in the presently described embodiments, it will be appreciated that a variety of other synthetic binder fibers, e.g., inexpensive polyesters, such as PBS, PET, and the like may alternatively or additionally be employed. Other possible fibers that may also be suitable for use may include polyethylene, PVC, and the like. In an embodiment, more expensive, so-called biodegradable or compostable polyester fibers (e.g., PLA, PHA, PBAT and the like) are avoided, as they are expensive and it can be difficult to incorporate such fibers into a substrate loaded with a cleaning composition as described herein (e.g., there are often compatibility problems with such combinations).

Some portion of the fibers of the nonwoven substrate may be formed of natural fibers or derivatives of natural fibers. In an embodiment, such natural fibers may comprise pulp fibers (e.g., wood pulp), or be derived from such fibers. Such natural fibers may typically be of shorter length than typical synthetic fibers.

The basis weight of the nonwoven substrates or individual layers thereof may be expressed in grams per square meter (gsm), and may be, for example, no more than 200 gsm, no more than 150 gsm, no more than 100 gsm, such as from 5 to 80 gsm, from 10 to 60 gsm or from 20 to 80 gsm.
It will be appreciated that the present wipes may include any of various textures, or perhaps no texture at all. Various textures are shown in Applicant's U.S. Pat. No. 11,472,164, herein incorporated by reference in its entirety.

In an embodiment, at least 20%, at least 25%, or at least 30% of the fibers in the nonwoven substrate may comprise natural fibers (e.g., pulp fibers). By way of example, from 30% to 65% of the fibers in the nonwoven substrate may comprise natural fibers. For example, 20%, 25%, 30%, 35%, 40%, 45%, 50%, 55%, 60% 65%, 70%, 75%, or 80% of the fibers may comprise natural fibers.

In an embodiment, at least 25%, at least 30% or at least 35% of the fibers in the nonwoven substrate may comprise synthetic binder fibers (e.g., polypropylene). By way of example, from 35% to 70% of the fibers in the nonwoven substrate may comprise synthetic binder fibers (e.g., polypropylene fibers). For example, 25%, 30%, 35%, 40%, 45%, 50%, 55%, 60% 65%, 70%, 75% or 80% of the fibers may comprise synthetic binder fibers (e.g., polypropylene fibers). Such polypropylene or other synthetic fibers may comprise TiO₂ or another opacifier as described herein.

It may be advantageous that any processing that the nonwoven substrate undergoes (e.g., calendaring, drying, or the like) be at a temperature that is sufficiently low to ensure that any pulp or other plant-based natural or naturally derived fibers do not ignite, or become embrittled or discolored due to “burning”, which may occur near the paper ignition temperature of 233° C.

The nonwoven substrates may be packaged within any desired container system. Examples of such include, but are not limited to flex packs, cylinders, tubs, or other containers for storage and dispensing.

In some embodiments, it may be desirable to provide the substrate with a lofted structure, so as to increase the bulk and thickness of the substrate. Such lofting may be provided by any suitable technique that may increase the bulk and thickness of the layer, by adding lofted material thereto, which includes gaps, air pockets, and/or a fuzzy, lofted characteristic. While such lofting is possible, such lofting can be expensive, and the present disclosure advantageously describes alternative methods of achieving high perceived thickness, with reduced expense.

### IV. True Thickness

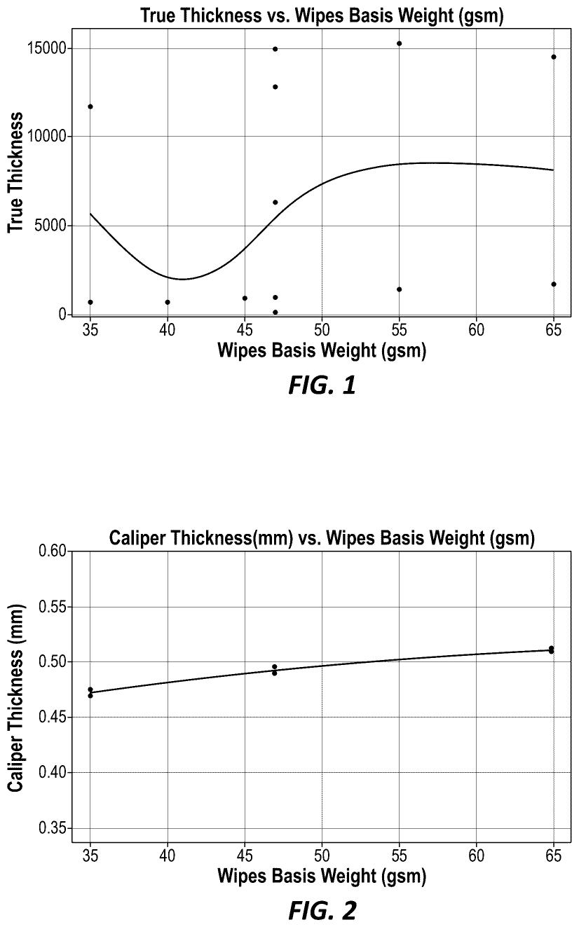

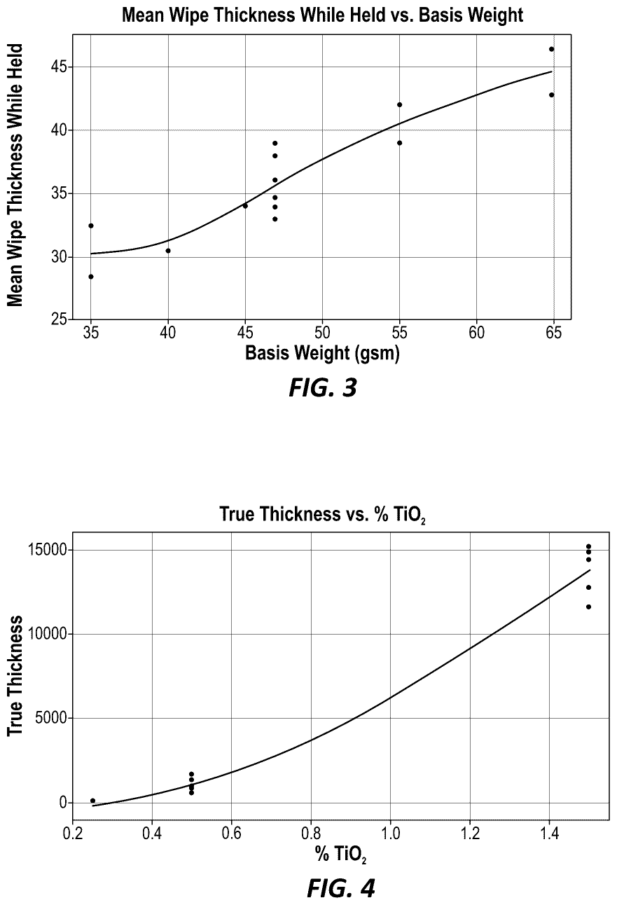

In order to more accurately capture the perception of thickness experienced by consumers relative to, for example, measured ‘thickness’ as defined solely by a caliper measurement, the True Thickness (“TT”) of a substrate may be determined. In a described embodiment, the TT formula incorporates the measurable attributes of (i) basis weight, (ii) reciprocal of mean hole area, (iii) total visual density, and (iv) texture rating. True Thickness is not solely a function of the amount of material employed in the substrate, nor a simple caliper measurement of actual thickness. As shown in FIG. 1, higher basis weight materials may have lower TT values and vice versa, such that basis weight is not indicative of perceived thickness, by itself. Indeed, as shown in FIG. 2, an increase in basis weight does not necessarily correspond to any significant increase in measured thickness, due to limitations like pulp fiber swelling. Yet, as shown in FIG. 3, an increase in basis weight does contribute to an increase in the perception of thickness amongst trained human evaluators. It is readily apparent from such data that humans are sensitive to basis weight, and perceive increased thickness with increased basis weight, even if measured thickness is not significantly increased. The data shown in FIG. 3 was generated using eleven trained human evaluators who rated the perceived wipe thickness on a 7-point continuous line scale. To assess thickness, trained evaluators held the wipe between their thumb and index finger and moved their fingers across the sample with light pressure. The samples were blinded with 3-digit codes and served one at a time in a randomized order. All of the trained evaluators evaluated each product twice.

Similarly, as shown in FIG. 4, an increase in TiO₂ or other opacifier content in the polypropylene or other synthetic binder fibers greatly increases the perceived thickness, even where measured thickness may not increase.

In an embodiment, TT may be determined as follows:

$$TT = Basis Weight ( gsm ) \times ( \frac{1}{Mean Hole Area} ) \times Total Visual Density \times Texture Rating \qquad Equation 1$$

In this formula, (i) “Basis Weight” is the weight of the nonwoven substrate or individual layers thereof measured in grams per square meter (gsm). (ii) is the “Mean Hole Area” is the percent transparency (e.g., as determined by particle analysis), measured as the amount of a dark background that shows through a region of interest in the substrate. (iii) is the “Total Visual Density” (shown in Equation 3 below), which is the percentage of TiO₂ or similar opacifier included in the polypropylene (“PP”) or other synthetic binder fibers, times a quotient of the basis weight of the polypropylene fibers or other synthetic binder fibers (in gsm) relative to the basis weight of the nonwoven substrate as a whole (in gsm). (iv) “Texture Rating” is the TS750 texture rating of the substrate, which is a standard characteristic that will be apparent to those of skill in the art.

The basis weight of the substrates of the present disclosure is a standard measurement, e.g., routinely provided by manufacturers for any given substrate material, the determination of which will be apparent to those of skill in the art. In a typical embodiment, the nonwoven substrates of the present disclosure may have a basis weight of from about 20 gsm to about 80 gsm.

The mean hole area of the substrate is the percent transparency (as determined by particle analysis) of the substrate. It may be evaluated, for example, by identifying a region of interest (ROI) within the wipe (e.g., the area of the wipe that is a given minimum distance from any perimeter edge) and measuring a degree of background color that shows through that area when the wipe is illuminated from above. For example, samples may be imaged using a color calibrated DigiEye or similar imaging system, including a light box with diffuse lighting and a top-mounted camera, such as a Nikon D7000 or similar camera. Parameters for imaging may be set to accommodate, for example, a D65 illuminant and a 10 degree observer. The wipe substrate may be imaged against a colored background—for example, a black background—in order to measure the amount of the colored background (black) that shows through the substrate. Replicate samples may be evaluated for each test substrate, to determine an average value.

In order to analyze the images obtained using this method, a particle-analysis-based opacity/transparency (defined as average hole area as percent (%) of ROI—i.e., “Mean Hole Area”) may be measured to evaluate the amount of dark colored area that shows through the test substrates. This value may be determined as follows:
(1) Undertake image processing steps (for example, in LabView Vision Assistant);
(2) Apply image mask to define the ROI. For example, the ROI may be the interior of each substrate, away from the peripheral edges (e.g., 5 mm, or 1 cm away from such edges);
(3) Extract intensity color plane; and
(4) Apply a threshold to select dark areas that show through the test substrate.

For example, the threshold may be set to select dark areas with pixel intensities at or below 125 (e.g., within an 8-bit scale running from 0 to 255). The same threshold should be used for all substrates evaluated. Particle analysis may be used to determine the total pixel area of particles or pixels at or below the 125 threshold (i.e., the ‘dark areas’), as well as the total ROI pixel area. A particle analysis-based transparency (also referred to as “Mean Hole Area”) may be calculated from these two pixel areas.

For example, the particle analysis-based transparency, i.e. Mean Hole Area, may be calculated as follows:

$$Mean Hole Area = \frac{Total Pixels \underline{<} 125}{Total ROI Pixels} * 100 \qquad Equation 2$$

The reciprocal of mean hole area, which roughly captures the mean opacity of the substrate, is used to calculate TT. Relatively lower mean hole area values (i.e., less of the black background showing through the substrate) are advantageous for increasing TT and perceived thickness. By way of example, exemplary reciprocal values of mean hole area may be greater than 1.0, such as from 1.0 to 2.0.

As discussed above, Total Visual Density may be measured as follows:

$$Total Visual Density = ( \% TiO 2 in PP fibers ) \times ( \frac{Basis Weight PP fibers}{Basis Weight Nonwoven Substrate} ) \qquad Equation 3$$

Generally, TiO₂ is used in the textile industry to impart certain properties to fibers, such as UV protection, delustering, durability, visual shielding, and/or antimicrobial properties. In the present disclosure, TiO₂ is included in the PP fibers for at least the additional reason that it contributes to opacity and, thus, to the perceived thickness of the resulting wipe. In an exemplary embodiment, the PP fibers of the present disclosure include more than 0.5% TiO₂ by weight, such as at least about 1% TiO₂ by weight, or from about 0.6% to about 5% TiO₂ by weight, or from about 0.8% to about 2% TiO₂ by weight. Exemplary values for TiO₂ or another opacifier in the polypropylene or other synthetic binder resin may include 0.55%, 0.6%, 0.7%, 0.8%, 0.9%, 1%, 1.5%, 2%, 2.5%, 3%, 3.5%, 4%, or 5% by weight of the resin used to form the polypropylene or other synthetic fibers. In an embodiment, the PP or other synthetic fibers may comprise at least 35% by weight of the fibers included in the nonwoven substrate, such as from about 35% to about 70% by weight of the fibers included in the nonwoven substrate. In an embodiment, the remainder of the fibers are natural fibers (e.g., pulp fibers), and may comprise from about 30% to about 65% by weight of the overall nonwoven substrate fibers included in the nonwoven substrate.

While TiO₂ is a particularly suitable opacifier, alternatives to TiO₂ exist which, if incorporated into PP or other synthetic spunbound or other fiber materials, may provide similar benefits. Such alternatives include but are not limited to calcined kaolin, calcium carbonate, barium sulfate, lithopone (a co-precipitate of barium sulfate (BaSO₄) and zinc sulfide (ZnS), and synthetic silicates. Combinations of such materials may also be suitable for use. In an embodiment where an alternative to TiO₂ and/or another synthetic binder fiber is used, the TT can be calculated by incorporating the percentage of the alternative opacifier and/or alternative synthetic binder fiber into the Total Visual Density calculation (Equation 3), discussed above.

Relatively higher total visual density values are advantageous for increasing TT and perceived thickness. By way of example, exemplary total visual values may be greater than 0.4, such as from 0.45 to 1.0. Such values are driven by the opacifier content, as well as the percentage of the nonwoven substrate that is formed from the polypropylene or other synthetic binder resin. Higher values for both such variables increases TT and perceived thickness. For example, including at least about 1% TiO₂ or other opacifier and at least 35% by weight polypropylene or other synthetic binder fibers increases total visual density, aiding in achievement of a TT value of at least 5000.

Texture—as incorporated in the TT formula—may be measured using a standard texture rating such as TS750. A TS750 rating is measured on a TSA instrument, such as an Emtec Tissue Softness Analyzer, that provides an objective measurement of tissue softness, or hand feel. Those of skill in the art will appreciate that a TSA instrument comprises the following parts:
1. Measuring head—Vertical travel is controlled by a high-precision stepper motor.
2. Rotor and blades—Housed in the measuring head, the blades are specially selected for their frequency response.
3. Measuring cell—A fixing ring locks the sample atop an open cell. At the bottom of the cell is a microphone to measure the sound.
4. Vibration sensor—Contains a load cell and balance to ensure the proper force into the sample and a stable environment before measurement.
5. External microphone—Detects surrounding noise, which will be canceled from the signal for processing.

Measurement on a TSA instrument is a sound analysis. The head is lowered until the rotor is pressed onto the sample at a pressure of, for example, 100 mN. Once it is determined that the pressure is stable, the rotor will turn, causing the blades to rub the sample. The generated sound is recorded and processed by the software to generate two peaks: TS7 and TS750. The TS750 peak occurs between 200-2000 Hz, and represents the roughness of the sample. Embossing, creping, etc. will all have a direct effect on this value. The texture of the sheet is a series of peaks and valleys. As the blades pass over, the sheet is forced down and released, creating a vibration. The greater the texture, the greater the vibration, resulting in a higher amplitude of the TS750 peak.

Those of skill in the art will appreciate that TS750 is a standard measurement that can be determined for any of various nonwoven substrates. Relatively higher total TS750 values are advantageous for increasing TT and perceived thickness. By way of example, exemplary TS750 values may be greater than 200, such as from about 250 to 350, or from about 250 to about 300. It will be appreciated that achievement of the desired TT value of greater than 5000 is achieved through a combination of particular selections, including the TS750 value, e.g., in combination with basis weight, reciprocal of mean hole area, and total visual density.

In an exemplary embodiment, the TT value (as recited in Equation 1 above) is at least 5000 for wipes comprising polypropylene and natural fibers (e.g., pulp fibers), in order to optimize consumer perception of thickness of the wipe. To achieve the desired value, the substrate can be designed accordingly by modifying any or all of the four measured attributes (identified in Equation 1 above) to acquire values that are tailored to yield a target TT value that is greater than 5000. Each of the measured attributes is important, such that no single attribute alone is definitive.

While TT is determined as noted above, by multiplying the various measured attributes, alternative formulas could weigh the different attributes differently, or add them, rather than multiplying them. It will therefore be appreciated that the given formula for determining TT is merely exemplary.

### V. Cleaning Composition

### A. Antimicrobial Agent

Many cleaning composition components as known within the art may be suitable for use in the present pre-dosed wipes. In an embodiment, the cleaning composition is an aqueous composition, including at least 70%, at least 80%, at least 90%, or at least 95% water by weight (e.g., 95% to 99% water). The composition may include a quaternary ammonium compound as an antimicrobial agent. For example, the quaternary ammonium compound may be included from 0.05%, from 0.1%, up to 5%, up to 4%, up to 3%, up to 2%, up to 1.5%, or up to 1% by weight of the cleaning composition. In an embodiment, the quaternary ammonium compound is present as two or more quaternary ammonium compounds. When at least two quaternary ammonium compounds are present, the first quaternary ammonium compound is present in an amount of less than 1% by dry weight of the loaded wipe as a whole and the second quaternary ammonium compound is present in an amount of less than 1% by dry weight of the loaded wipe as a whole. Collectively the two or more quaternary ammonium compounds may be present in an amount of greater than 1% to about 5%, by dry weight of the loaded wipe as a whole.

Quaternary ammonium compounds have broad spectrum antimicrobial properties. A variety of different quaternary ammonium compounds can be used in the cleaning composition. Non-limiting examples of quaternary ammonium compounds are typically halides (e.g., a chloride) of alkyldimethylbenzylammonium, alkyldimethylethylbenzylammonium, alkyldimethylammonium, or the like. The alkyl groups of such quaternary ammonium compounds may typically range from C₁₂ to C₁₈. Quaternary ammonium compounds are described in more detail in U.S. Pat. No. 6,825,158, incorporated by reference herein, and will already be familiar to those of skill in the art.

In an embodiment, the quaternary ammonium compound may be the only included antimicrobial agent, if an antimicrobial agent is present. In another embodiment, an organic acid (e.g., citric acid) may be present in sufficiently high amounts to serve as an antimicrobial agent (e.g., from 0.3% to 5%, or from 0.5% to 3% by weight of the cleaning composition). One or more such acids may alternatively be present in a small amount, for another purpose, such as a buffer or pH adjuster (e.g., in an amount of less than 0.1%, less than 0.05%, or no more than 0.01% by weight of the cleaning composition).

### B. Solvents

The composition may include a solvent, such as a glycol ether solvent. Exemplary glycol ether solvents include, but are not limited to, ethylene glycol monopropyl ether, ethylene glycol monobutyl ether, ethylene glycol monohexyl ether, ethylene glycol phenyl ether, propylene glycol n-propyl ether, propylene glycol monobutyl ether, propylene glycol t-butyl ether, diethylene glycol monoethyl or monopropyl or monobutyl ether, di- or tri-polypropylene glycol methyl or ethyl or propyl or butyl ether, acetate and/or propionate esters of glycol ethers. The glycol ether or other solvent may be included from 0.1%, from 0.25%, up to 5%, up to 4%, up to 3%, up to 2%, or up to 1% by weight of the cleaning composition. Other solvents, surfactants, and various other adjuvants often included in cleaning compositions may optionally be present. While some embodiments may include lower alcohol solvents (e.g., C₁-C₄ alcohols), the amount of such volatile solvents may be limited, e.g., to less than 10%, less than 5%, less than 3%, less than 2%, less than 1%, less than 0.5%, or less than 0.3% by weight. Other alcohol solvents can also be used (e.g., C₅ and higher, such as C₆ to C₁₆, C₈ to C₁₂, C₁₀, etc.). In some embodiments, the composition may be free of, or substantially free of, such lower alcohol or other highly volatile solvents. In an embodiment, the composition may include, or alternatively be free of diols, e.g., alkanediols.

### C. Surfactants

Those of skill in the art will appreciate that any among a wide variety of surfactants (e.g., anionic, cationic, non-ionic, zwitterionic, and/or amphoteric) may be included in the cleaning composition, as desired. Where included, a surfactant may be present from 0.05%, from 0.1%, up to 10%, up to 5%, up to 4%, up to 3%, up to 2%, or up to 1% by weight of the cleaning composition. Various surfactants and other optional adjuvants are disclosed in U.S. Pat. No. 3,929,678 to Laughlin and Heuring, U.S. Pat. No. 4,259,217 to Murphy, U.S. Pat. No. 5,776,872 to Giret et al.; U.S. Pat. No. 5,883,059 to Furman et al.; U.S. Pat. No. 5,883,062 to Addison et al.; U.S. Pat. No. 5,906,973 to Ouzounis et al.; U.S. Pat. No. 4,565,647 to Llenado, and U.S. Publication No. 2013/0028990. The above patents and applications are each herein incorporated by reference in their entirety.

Examples of nonionic surfactants include, but are not limited to, alcohol ethoxylates, alcohol propoxylates, other alcohol alkoxylates including fatty (e.g., C₆, C₈, C₁₀, or C₁₂, or higher) alcohols or other constituents that have been alkoxylated to include both ethoxy and propoxy groups (EO-PO surfactants), alkyl phosphine oxides, alkyl glucosides and alkyl pentosides, alkyl glycerol esters, alkyl ethoxylates, and alkyl and alkyl phenol ethoxylates of all types, poly alkoxylated (e.g. ethoxylated or propoxylated) C₆-C₁₂ linear or branched alkyl phenols, C₆-C₂₂ linear or branched aliphatic primary or secondary alcohols, and C₂-C₈ linear or branched aliphatic glycols. Block or random copolymers of C₂-C₆ linear or branched alkylene oxides may also be suitable nonionic surfactants. Capped nonionic surfactants in which the terminal hydroxyl group is replaced by halide; C₁-C₈ linear, branched or cyclic aliphatic ether; C₁-C₈ linear, branched or cyclic aliphatic ester; phenyl, benzyl or C₁-C₄ alkyl aryl ether; or phenyl, benzyl or C₁-C₄ alkyl aryl ester may also be used. Sorbitan esters and ethoxylated sorbitan esters may also be useful nonionic surfactants. Other suitable nonionic surfactants may include mono or polyalkoxylated amides of the formula R¹CONR²R³ and amines of the formula R¹NR²R³ wherein R¹ is a C₅-C₃₁ linear or branched alkyl group and R² and R³ are C₁-C₄ alkyl, C₁-C₄ hydroxyalkyl, or alkoxylated with 1-3 moles of linear or branched alkylene oxides. Biosoft 91-6 (Stepan Co.) is an example of an alkyl ethoxylate (or alcohol ethoxylate) having a methylene chain length of C₉ to C₁₁ with an average of 6 moles of ethoxylation. An example of an alcohol ethoxylate is ECOSURF EH-9, which is more specifically an ethylene oxide-propylene oxide copolymer mono(2-ethylhexyl) ether, available from Sigma-Aldrich.

Alkylpolysaccharide nonionic surfactants are disclosed in U.S. Pat. No. 4,565,647 to Llenado, having a linear or branched alkyl, alkylphenyl, hydroxyalkyl, or hydroxyalkylphenyl group containing from 6 to 30 carbon atoms and a polysaccharide, e.g., a polyglycoside, hydrophilic group containing from 1.3 to 10 saccharide units. Suitable saccharides may include, but are not limited to, glucosides, galactosides, lactosides, and fructosides. Alkylpolyglycosides may have the formula: R²O(CnH₂ₙO)ₜ(glycosyl)ₓ wherein R² is selected from the group alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 10.

Fatty acid saccharide esters and alkoxylated fatty acid saccharide esters may also be suitable for use in the present invention. Examples include, but are not limited to, sucrose esters, such as sucrose cocoate, and sorbitan esters, such as polyoxyethylene(20) sorbitan monooleate and polyoxyethylene(20) sorbitan monolaurate.

Phosphate ester surfactants may also be suitable. These include mono, di, and tri esters of phosphoric acid with C₄-C₁₈ alkyl, aryl, alkylaryl, alkyl ether, aryl ether and alkylaryl ether alcohols (e.g. disodium octyl phosphate).

Zwitterionic surfactants may be suitable. As zwitterionic surfactants include both a positive and negative functional group, they may also be classified as nonionic surfactants. Many such zwitterionic surfactants contain nitrogen. Examples of such include amine oxides, sarcosinates, taurates and betaines. Examples include C₈-C₁₈ alkyldimethyl amine oxides (e.g., octyldimethylamine oxide, lauryldimethylamine oxide (also known as lauramine oxide), and cetyldimethylamine oxide), C₄-C₁₆ dialkylmethylamine oxides (e.g. didecylmethylamine oxide), C₈-C₁₈ alkyl morpholine oxide (e.g. laurylmorpholine oxide), tetra-alkyl diamine dioxides (e.g. tetramethyl hexanane diamine dioxide, lauryl trimethyl propane diamine dioxide), C₈-C₁₈ alkyl betaines (e.g. decylbetaine and cetylbetaine), C₈-C₁₈ acyl sarcosinates (e.g. sodium lauroylsarcosinate), C₈-C₁₈ acyl C₁-C₆ alkyl taurates (e.g. sodium cocoylmethyltaurate), C₈-C₁₈ alkyliminodipropionates (e.g. sodium lauryliminodipropionate), and combinations thereof. Lauryl dimethyl amine oxide (Ammonyx LO) myristyl dimethyl amine oxide (Ammonyx MO), decylamine oxide (Ammonyx DO) are examples of suitable zwitterionic surfactants, available from Stepan Co.

Non-limiting examples of anionic surfactants include alkyl sulfates (e.g., C₈-C₁₈ linear or branched alkyl sulfates such as sodium lauryl sulfate (SLS), and sodium tetradecylsulfate), alkyl sulfonates (e.g., C₆-C₁₈ linear or branched alkyl sulfonates such as sodium octane sulfonate and secondary alkane sulfonates, alkyl ethoxysulfates, fatty acids and fatty acid salts (e.g., C₆-C₁₆ fatty acid soaps such as sodium laurate), and alkyl amino acid derivatives. Other examples may include sulfate derivatives of alkyl ethoxylate propoxylates, alkyl ethoxylate sulfates, alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methylsulfonates, C₆-C₁₈ alkyl, aryl, or alkylaryl ether carboxylates, sulfonated alkyldiphenyloxides (e.g. sodium dodecyldiphenyloxide disulfonate), and the like.

More specific examples of nonionic and/or zwitterionic surfactants include lauryl dimethyl amine oxide (Ammonyx LO), also known as lauramine oxide, myristyl dimethyl amine oxide (Ammonyx MO), decylamine oxide (Ammonyx DO), other amine oxides, any betaines, linear alcohol ethoxylates, alcohol propoxylates, alkyl polyglucosides, and combinations thereof.

### D. Additional Adjuvants

The cleaning composition may optionally include and/or be used in combination with one or more additional adjuncts. The adjuncts include, but are not limited to, fragrances or perfumes, waxes, dyes and/or colorants, solubilizing materials, stabilizers, thickeners, defoamers, hydrotropes, buffers, builders, lotions and/or mineral oils, enzymes, bleaching agents, cloud point modifiers, and/or preservatives. A variety of builder detergents can be used in and/or used in combination with the cleaning composition. Such builder detergents include, but are not limited to, phosphate-silicate compounds, zeolites, alkali metal, ammonium and substituted ammonium polyacetates, mono-, di-, and tri-alkali salts of nitrilotriacetic acid, carboxylates, aluminosilicate materials, silicates, polycarboxylates, zeolites, carbonates, phosphates, bicarbonates, polyphosphates, amines, alkanolamines, aminopolycarboxylates, polyhydroxysulfonates, starch derivatives, ethylenediamine tetraacetate, and/or metal ion sequestrants (e.g., aminopolyphosphonates such as, but not limited to, ethylenediamine tetramethylene phosphonic acid and diethylene triamine pentamethylenephosphonic acid).

In one embodiment, the builder detergent includes polyacetate and/or polycarboxylate compounds. In one aspect of this embodiment, the polyacetate and/or polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid.

In one embodiment, the buffering and pH adjusting agents, when used, include, but are not limited to, organic acids, mineral acids, alkali metal and alkaline earth salts of citrate, silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and/or 2-amino-2methylpropanol.

A buffering agent can be an active detergent in its own right, and/or can be a low molecular weight, organic or inorganic material used for maintaining the desired pH. The buffer can be alkaline, acidic or neutral. Non-limiting examples of buffering agents include nitrogen-containing materials (e.g., lysine; lower alcohol amines like mono-, di-, and tri-ethanolamine; tri(hydroxymethyl) amino methane; 2-amino-2-ethyl-1,3-propanediol; 2-amino-2-methyl-propanol; 2-amino-2-methyl-1,3-propanol; disodium glutamate; methyl diethanolamide; 2-dimethylamino-2-methylpropanol; 1,3-bis(methylamine)-cyclohexane; 1,3-diamino-propanol N,N′-tetra-methyl-1,3-diamino-2-propanol; N,N-bis(2-hydroxyethyl)glycine; tris(hydroxymethyl)methyl glycine; ammonium carbamate; citric acid; acetic acid; ammonia; alkali metal carbonates; and/or alkali metal phosphates). For additional buffers that can be used, see McCutcheon's EMULSIFIERS AND DETERGENTS, North American Edition, 1997, McCutcheon Division, MC Publishing Company which is incorporated herein by reference. In yet another and/or alternative embodiment, solubilizing materials, when used, can include, but are not limited to, hydrotropes (e.g., water soluble salts of low molecular weight organic acids such as the sodium and/or potassium salts of xylene sulfonic acid). In another and/or alternative embodiment, the acids, when used, include, but are not limited to, organic hydroxy acids, citric acids, keto acid, and the like.

In still another and/or alternative embodiment, thickeners, when used, include, but are not limited to, polyacrylic acid, xanthan gum, calcium carbonate, aluminum oxide, alginates, guar gum, methyl, ethyl, clays, and/or propylhydroxycelluloses. In yet another and/or alternative embodiment, defoamers, when used, include, but are not limited to, silicones, aminosilicones, silicone blends, and/or silicone/hydrocarbon blends. In yet a further and/or alternative embodiment, bleaching agents, when used, include, but are not limited to, peracids, perborates, percarbonates, chlorine-generating substances (e.g., chloroisocyanurates hypohalite sources), hydrogen peroxide, and/or sources of hydrogen peroxide. In still a further and/or alternative embodiment, preservatives, when used, include, but are not limited to, mildewstats or bacteriostats, methyl, ethyl and propyl parabens, short chain organic acids (e.g., acetic, lactic and/or glycolic acids), bisguanidine compounds (e.g., Dantagard and/or Glydant) and/or short chain alcohols (e.g., ethanol and/or IPA). In one aspect of this embodiment, the mildewstats or bacteriostats include, but are not limited to, mildewstats (including non-isothiazolone compounds) include Kathon GC, a 5-chloro-2-methyl-4-isothiazolin-3-one, Kathon ICP, a 2-methyl-4-isothiazolin-3-one, and a blend thereof, and Kathon 886, a 5-chloro-2-methyl-4-isothiazolin-3-one, all available from Rohm and Haas Company; Bronopol, a 2-bromo-2-nitropropane-1,3-diol, from Boots Company Ltd.; Proxel CRL, a propyl-p-hydroxybenzoate, from ICI PLC; Nipasol M, an o-phenyl-phenol, Na+ salt, from Nipa Laboratories Ltd.; Dowicide A, a 1,2-Benzoisothiazolin-3-one, from Dow Chemical Co.; and Irgasan DP 200, a 2,4,4′-trichloro-2-hydroxydiphenylether, from Ciba-Geigy A.G.

### E. Other Characteristics

As used herein the term “liquid” and “cleaning composition” includes, but is not limited to, solutions, emulsions, suspensions and so forth. Thus, liquid cleaning compositions may comprise and/or contain one or more of the following: disinfectants; antiseptics; sterilants; sporicides; germicides; bactericides; fungicides; virucides; protozoacides; algicides; bacteriostats; fungistats; virustats; sanitizers; antibiotics; pesticides; other antimicrobial agents; diluents; surfactants, such as nonionic, anionic, cationic; waxes; and so forth. Examples of some such components are included in, but not limited to, U.S. Pat. Nos. 6,825,158; 8,648,027; 9,006,165; 9,234,165; 9,988,594; 10,421,929 and U.S. Publication No. 2008/003906, each of which is herein incorporated by reference in its entirety.

Additional non-limiting examples of cleaning compositions and components which may be included in the present embodiments are disclosed in U.S. Pat. No. 5,460,833 to Andrews et al.; U.S. Pat. No. 6,221,823 to Crisanti; U.S. Pat. No. 6,346,279 to Rochon et al.; U.S. Pat. No. 6,551,980 to Wisniewski et al.; U.S. Pat. No. 6,699,825 to Rees et al.; U.S. Pat. No. 6,803,057 to Ramirez et al.; U.S. Pat. No. 6,812,196 to Rees et al.; U.S. Pat. No. 6,936,597 to Urban; U.S. Pat. No. 7,008,600 to Katsigras et al.; U.S. Pat. No. 7,070,737 to Bains et al.; U.S. Pat. No. 7,354,604 to Ramirez et al.; U.S. Pat. No. 7,598,214 to Cusack et al.; U.S. Pat. No. 7,605,096 to Tamarchio et al.; U.S. Pat. No. 7,658,953 to Bobbert; U.S. Pat. No. 7,696,143 to McCue et al.; U.S. Pat. No. 7,915,207 to Chopskie et al.; U.S. Pat. No. 8,569,220 to Gaudrealt; U.S. Pat. No. 8,575,084 to Gaudrealt; U.S. Pat. No. 10,064,409 to Hazenkamp et al.; U.S. Pat. No. 10,076,115 to Salminen et al.; U.S. Pat. No. 10,358,624 to Mitchell et al.; U.S. Publication No. 2007/0190172 to Bobbert; PCT Publication Nos. WO 99/18180 to Raso et al.; WO 99/53006 to Masotti et al.; WO 2004/067194 to Arrigoni et al.; WO 2004/104147 to Rosiello et al.; WO 2017/174959 to Convery; and EPO Publication EP 2843034 to Nedic et al., each of which is herein incorporated by reference in its entirety.

In some embodiments, it may be possible to provide the substrates in dry form, where dosing with a selected disinfection, sanitization, or even another cleaning composition may occur later (e.g., by the user). In another embodiment, the wipes may be dosed with a solid disinfecting, sanitizing or other cleaning composition, where the user may add water to the wipes, at or shortly before the time of use, resulting in the dosed wipes, ready for use. Pre-dosed wipes may be preferred, e.g., as the amount and concentrations of the components in the cleaning composition, and the loading ratio of such composition relative to the absorbent substrate can be more carefully controlled during manufacture, than may occur where the final composition may depend on the user for dilution or water addition.

With regard to pre-moistened substrates, a selected amount of liquid may be added to the container or wipes during manufacture such that the cleaning substrates contain the desired amount of liquid. The substrates are not necessarily loaded to their saturation point, but are typically loaded with the cleaning composition to some ratio less than full saturation. For example, many substrates are capable of holding about 8 to 14 times their weight in liquid, although in an embodiment the substrates may be loaded at a loading ratio less than saturation, e.g., less than 8:1, less than 7:1, less than 6:1, less than 5:1, less than 4.5:1, less than 4:1, such as from 1:1 to 6:1, from 2:1 to 5:1, from 2.5:1 to 4.5:1, or from 3:1 to 4:1.

It is important to understand and account for how the substrate materials affect the chemistry of the cleaning composition being dosed onto the wipes. For example, it can be important to avoid or minimize unwanted chemical interactions that may inadvertently deactivate the active agents within the cleaning composition. For example, incompatibility between components in the composition versus the substrate can occur, which would be undesirable. The composition that is released from the pre-loaded wipe is referred to as the “squozate”. When components of a composition react with or bind to a substrate, the composition that is loaded onto the substrate differs from the “squozate”. It is desirable that an effective amount of any given active agent not only be loaded into the wipe, but actually be released in the “squozate” from such wipe, during use.

The size and shape of the wipe can vary with respect to the intended application and/or end use of the same. The cleaning substrate can have a substantially rectangular shape of a size that allows it to readily engage standard cleaning equipment or tools such as, for example, mop heads, duster heads, brush heads, mitten shaped tools for wiping or cleaning, and so forth. In another embodiment, another shape, (e.g., circular, oval, or the like) may be provided.

The wipes or other cleaning substrates may be provided pre-moistened with a disinfecting, sanitizing, or other cleaning composition. The wet cleaning substrates can be maintained over time in a sealable container such as, for example, within a bucket or tub with an attachable lid, sealable bags, plastic pouches (e.g., “flex packs”), canisters, jars, and so forth. Desirably the wet, stacked cleaning substrates are maintained in a resealable container. The use of a resealable container is particularly desirable when using aqueous volatile liquid compositions since substantial amounts of water or other liquid can evaporate while using the first sheets thereby leaving the remaining sheets with little or no liquid. Exemplary resealable containers and dispensers include, but are not limited to, those described in U.S. Pat. No. 4,171,047 to Doyle et al., U.S. Pat. No. 4,353,480 to McFadyen, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference.

Typically, the disinfecting, sanitizing, or other cleaning substrates are stacked and placed in the container and the liquid subsequently added thereto, all during mass manufacturing. No matter the packaging and dosing process, once manufactured and packaged, the substrate can subsequently be used to wipe a surface. The moistened cleaning substrates can be used to treat various surfaces. As used herein “treating” surfaces is used in the broad sense and includes, but is not limited to, wiping, polishing, swabbing, cleaning, washing, disinfecting, scrubbing, scouring, sanitizing, and/or applying active agents thereto.

The wipes or other cleaning substrates of the present disclosure can be provided in a kit form, wherein a plurality of cleaning substrates and a cleaning tool are provided in a single package.

In addition to material composition and construction, wipe or other substrate dimensions can also be used to control dosing as well as provide ergonomic appeal. In one embodiment, substrate dimensions are from about 51%2 inches to about 11 inches in length, and from about 512 inches to about 11 inches in width to comfortably fit in a hand. The substrate can have dimensions such that the length and width differ by no more than about 2 inches. Larger substrates may be provided that can be used and then folded, either once or twice, so as to contain dirt within the inside of the fold and then the wipe can be re-used. Such larger substrates may have a length from about 5%/2 inches to about 13 inches and a width from about 10 inches to about 13 inches. Such substrates can be folded once or twice and still fit comfortably in the hand. As described above, the substrates may be sufficiently thin to have a basis weight of no more than 200 gsm, no more than 150 gsm, no more than 100 gsm, such as from 5 to 80 gsm, or from 10 to 60 gsm. The ability to achieve a perceived thickness in the eyes of a typical consumer that is thicker than an actual caliper measured thickness is advantageous. For example, significantly thicker substrates (by caliper measurement) unnecessarily increase costs, waste generation, etc.

Exemplary multi-layer substrates can be tested for their ability to effectively deliver an antimicrobial quaternary ammonium compound (“quat”) or other active agent to a surface during simulated cleaning. By way of example, the substrates of the present disclosure may be loaded with cleaning compositions including from 0.1% to 3%, such as 0.1% to 2% by weight of the quaternary ammonium compound. In an embodiment, the wipes may release at least 40%, at least 50%, at least 55%, at least 60%, or at least 65% of the quaternary ammonium compound (i.e., quaternary ammonium compound in the squozate (i.e. the cleaning composition released from the substrate) as compared to the cleaning composition before loading). The wipes may exhibit at least a 3-log reduction in a target microbe, such as Staphylococcus aureus, within a given contact time frame (e.g., such as 5 minutes, 4 minutes, 3 minutes, 1 minute, 30 seconds, etc.).

The cleaning compositions may have a pH that may be acidic, or basic, e.g., depending on desired use. By way of example, pH may range from about 2 to about 12, such as 2, 3, 4, 5, 6, 7, 8, 9, 10, 11, or 12. Ranges between any such values are contemplated.

The cleaning compositions may have a desired viscosity. In an embodiment, the viscosity may be relatively low, e.g., less than 5,000, less than 3,000, less than 2,000, less than 1,000, less than 500, or less than about 100 cps. In an embodiment, the viscosity may be similar to that of water (e.g., a viscosity of about 1). Ranges between any such values are contemplated.

### VI. Examples

### Example 1

A substrate comprising a blend of PP fibers and pulp fibers has a basis weight of 47 gsm and comprises 0.25% TiO₂. The substrate of Example 1 has a mean hole area of 0.06%, a total visual density of 0.11, and a TS750 value of 254, yielding a True Thickness value of 80. Such a wipe is perceived by a typical consumer as being “cheap” and of low quality.

### Example 2

A commercially available substrate has a basis weight of 40 gsm and comprises 0.5% TiO₂. The substrate of Example 2 has a mean hole area of 0.32%, a total visual density of 0.25, and TS750 value of 193, yielding a True Thickness value of 626. Such a wipe is also perceived by a typical consumer as being “cheap” and of low quality.

### Example 3

An exemplary substrate comprising a blend of PP fibers and pulp fibers has a basis weight of 35 gsm and comprises 0.5% TiO₂. The substrate of Example 3 has a mean hole area of 0.26%, a total visual density of 0.29, and a TS750 value of 248, yielding a True Thickness value of 644. Such a wipe is also perceived by a typical consumer as being “cheap” and of low quality.

### Example 4

A comparative, commercially available substrate has a basis weight of 45 gsm and comprises 0.5% TiO₂. The substrate of Example 4 has a mean hole area of 0.47%, a total visual density of 0.22, and a TS750 value of 185, yielding a True Thickness value of 867. Such a wipe is also perceived by a typical consumer as being “cheap” and of low quality.

### Example 5

An exemplary substrate comprising a blended PP fibers and pulp fibers has a basis weight of 47 gsm and comprises 0.5% TiO₂. The substrate of Example 5 has a mean hole area of 0.36%, a total visual density of 0.21, and a TS750 value of 259, yielding a True Thickness value of 932. Such a wipe is also perceived by a typical consumer as being “cheap” and of low quality.

### Example 6

An exemplary substrate comprising a blend of PP fibers and pulp fibers has a basis weight of 47 gsm and comprises 0.5% TiO₂. The substrate of Example 6 has a mean hole area of 0.38%, a total visual density of 0.21, and a TS750 value of 254, yielding a True Thickness value of 958. Such a wipe is also perceived by a typical consumer as being “cheap” and of low quality.

### Example 7

An exemplary substrate comprising a blend of PP fibers and pulp fibers has a basis weight of 55 gsm and comprises 0.5% TiO₂. The substrate of Example 7 has a mean hole area of 0.43%, a total visual density of 0.18, and a TS750 value of 317, yielding a True Thickness value of 1349. Such a wipe is also perceived by a typical consumer as being “cheap” and of low quality.

### Example 8

An exemplary substrate comprising a blend of PP fibers and pulp fibers has a basis weight of 65 gsm and comprises 0.5% TiO₂. The substrate of Example 8 has a mean hole area of 0.62%, a total visual density of 0.15, and a TS750 value of 271, yielding a True Thickness value of 1667. Such a wipe is also perceived by a typical consumer as being “cheap” and of low quality.

### Example 9

An exemplary substrate comprising a blend of PP fibers and pulp fibers has a basis weight of 47 gsm and comprises 1.0% TiO₂. The substrate of Example 9 has a mean hole area of 1.05%, a total visual density of 0.43, and a TS750 value of 299, yielding a True Thickness value of 6261. Such a wipe is perceived by a typical consumer as being significantly thicker than wipes of examples 1-8, and of significantly higher quality.

### Example 10

An exemplary substrate comprising a blend of PP fibers and pulp fibers has a basis weight of 35 gsm and comprises 1.5% TiO₂. The substrate of Example 10 has a mean hole area of 1.57%, a total visual density of 0.86, and a TS750 value of 248, yielding a True Thickness value of 11,673. Such a wipe is perceived by a typical consumer as being significantly thicker than wipes of examples 1-8, and of significantly higher quality.

### Example 11

An exemplary substrate comprising a blend of PP fibers and pulp fibers has a basis weight of 47 gsm and comprises 1.5% TiO₂. The substrate of Example 11 has a mean hole area of 1.68%, a total visual density of 0.64, and a TS750 value of 254, yielding a True Thickness value of 12,811. Such a wipe is perceived by a typical consumer as being significantly thicker than wipes of examples 1-8, and of significantly higher quality.

### Example 12

An exemplary substrate comprising a blended PP fibers and pulp fibers has a basis weight of 47 gsm and comprises 1.5% TiO₂. The substrate of Example 12 has a mean hole area of 1.68%, a total visual density of 0.64, and a TS750 value of 296, yielding a True Thickness value of 14,936. Such a wipe is perceived by a typical consumer as being significantly thicker than wipes of examples 1-8, and of significantly higher quality.

### Example 13

An exemplary substrate comprising a blend of PP fibers and pulp fibers has a basis weight of 55 gsm and comprises 1.5% TiO₂. The substrate of Example 13 has a mean hole area of 1.68%, a total visual density of 0.55, and a TS750 value of 302, yielding a True Thickness value of 15,232. Such a wipe is perceived by a typical consumer as being significantly thicker than wipes of examples 1-8, and of significantly higher quality.

### Example 14

An exemplary substrate comprising a blend of PP fibers and pulp fibers has a basis weight of 65 gsm and comprises 1.5% TiO₂. The substrate of Example 14 has a mean hole area of 1.78%, a total visual density of 0.46, and a TS750 value of 271, yielding a True Thickness value of 14,489. Such a wipe is perceived by a typical consumer as being significantly thicker than wipes of examples 1-8, and of significantly higher quality.

### Table 1

Examples 1-14 are shown in Table 1. True Thickness was calculated using Equation 1 and the values are shown in the Table. Table 1 also shows the actual caliper measured thickness of the wipes of Examples 1-14. As is apparent, the actual caliper thickness of Examples 9-14 is not significantly different from that of Examples 1-8, although surprisingly these samples exhibit a significantly greater perceived thickness (and higher perceived quality), as perceived by a typical consumer, because of their significantly higher True Thickness values.

TABLE 1

| | | | | | Wipes | | PP fiber | | |
|---|---|---|---|---|---|---|---|---|---|
| | | | | Caliper | Basis | | basis | Total | |
| | Mean | % | Mean Hole | Thickness | Weight | % PP | weight | Visual | True |
| Ex. ID | TS750 | TiO2 | Area % | (mm) | (gsm) | Fiber | (gsm) | Density | Thickness |
| Ex. 1 | 254 | 0.25 | 0.06 | 0.49 | 47 | 43 | 20 | 0.11 | 80 |
| Ex. 2 | 193 | 0.5 | 0.32 | 0.54 | 40 | 50 | 20 | 0.25 | 626 |
| Ex. 3 | 248 | 0.5 | 0.26 | 0.47 | 35 | 57 | 20 | 0.29 | 644 |
| Ex. 4 | 185 | 0.5 | 0.47 | 0.54 | 45 | 44 | 20 | 0.22 | 867 |
| Ex. 5 | 259 | 0.5 | 0.36 | 0.53 | 47 | 43 | 20 | 0.21 | 932 |
| Ex. 6 | 254 | 0.5 | 0.38 | 0.50 | 47 | 43 | 20 | 0.21 | 958 |
| Ex. 7 | 317 | 0.5 | 0.43 | 0.58 | 55 | 36 | 20 | 0.18 | 1,349 |
| Ex. 8 | 271 | 0.5 | 0.62 | 0.51 | 65 | 31 | 20 | 0.15 | 1,667 |
| Ex. 9 | 299 | 1 | 1.05 | 0.49 | 47 | 43 | 20 | 0.43 | 6,261 |
| Ex. 10 | 248 | 1.5 | 1.57 | 0.48 | 35 | 57 | 20 | 0.86 | 11,673 |
| Ex. 11 | 254 | 1.5 | 1.68 | 0.49 | 47 | 43 | 20 | 0.64 | 12,811 |
| Ex. 12 | 296 | 1.5 | 1.68 | 0.51 | 47 | 43 | 20 | 0.64 | 14,936 |
| Ex. 13 | 302 | 1.5 | 1.68 | 0.55 | 55 | 36 | 20 | 0.55 | 15,232 |
| Ex. 14 | 271 | 1.5 | 1.78 | 0.51 | 65 | 31 | 20 | 0.46 | 14,489 |

Without departing from the spirit and scope of this invention, one of ordinary skill can make various modifications to the invention to adapt it to various usages and conditions. As such, these changes and modifications are properly, equitably, and intended to be, within the full range of equivalence of the following claims.

1. A cleaning, sanitizing or disinfecting wipe comprising:
(i) a nonwoven substrate comprising a combination of (i) polypropylene fibers and/or other synthetic binder fibers and (ii) natural fibers; and
(ii) a cleaning, sanitizing or disinfecting composition loaded onto the nonwoven substrate, wherein the cleaning, sanitizing or disinfecting composition comprises:
(a) a surfactant; and
(b) water;
wherein the composition comprises at least 70% by weight of water;
wherein the wipe has a true thickness value of greater than 5000.

2. The wipe of claim 1, wherein true thickness is defined as basis weight of the nonwoven substrate (in gsm) times a reciprocal of mean hole area (in percent) times total visual density times a TS750 texture rating of the wipe.

3. The wipe of claim 2, wherein total visual density is defined as percentage of TiO₂ or other opacifier included in the polypropylene fibers (in percent) times a quotient of a basis weight of the polypropylene fibers and/or other synthetic binder fibers (in gsm) relative to the basis weight of the nonwoven substrate as a whole (in gsm).

4. The wipe of claim 1, wherein the polypropylene fibers and/or other synthetic binder fibers include more than 0.5% TiO₂ or other opacifier by weight.

5. The wipe of claim 1, wherein the polypropylene fibers and/or other synthetic binder fibers include at least about 1% TiO₂ or other opacifier by weight.

6. The wipe of claim 1, wherein the polypropylene fibers and/or other synthetic binder fibers include from about 0.6% to about 5% TiO₂ or other opacifier by weight.

7. The wipe of claim 1, wherein the polypropylene fibers and/or other synthetic binder fibers include from about 0.8% to about 2% TiO₂ or other opacifier by weight.

8. The wipe of claim 1, wherein the natural fibers comprise pulp fibers.

9. The wipe of claim 1, wherein the nonwoven substrate has a basis weight of from about 20 gsm to about 80 gsm.

10. The wipe of claim 1, wherein the nonwoven substrate is substantially void of biodegradable or compostable polyesters such as PBAT, PLA and PHA.

11. The wipe of claim 1, wherein the polypropylene fibers and/or other synthetic binder fibers comprise at least 35% by weight of the fibers included in the nonwoven substrate.

12. The wipe of claim 1, wherein the polypropylene fibers and/or other synthetic binder fibers comprise from about 35% to about 70% by weight of the fibers included in the nonwoven substrate.

13. The wipe of claim 1, wherein the natural fibers comprise at least 30% by weight of the fibers included in the nonwoven substrate.

14. The wipe of claim 1, wherein the natural fibers comprise from about 30% to about 65% by weight of the fibers included in the nonwoven substrate.

15. The wipe of claim 1, wherein the composition further comprises a quaternary ammonium compound.

16. The wipe of claim 1, wherein the composition comprises at least 90% by weight water.

17. A sanitizing or disinfecting wipe comprising:
(i) a nonwoven substrate comprising a combination of polypropylene fibers and natural fibers, wherein the polypropylene fibers comprise at least about 30% by weight of overall nonwoven substrate fibers of the nonwoven substrate, wherein the polypropylene fibers comprise TiO₂; and
(ii) a sanitizing or disinfecting composition loaded onto said nonwoven substrate, wherein the sanitizing or disinfecting composition comprises:
(a) a sanitizing or disinfecting agent that comprises at least one of a quaternary ammonium compound or an organic acid;
(b) a surfactant; and
(c) water;
wherein the composition comprises at least 90% by weight of water;
wherein the wipe has a true thickness value of greater than 5000, wherein true thickness is defined as (i) basis weight (in gsm) of the nonwoven substrate times (ii) a reciprocal of mean hole area (in percent) times (iii) total visual density times (iv) a TS750 texture rating of the nonwoven substrate, wherein total visual density is defined as percentage of TiO₂ included in the polypropylene fibers (in percent) times a percentage of the overall nonwoven substrate fibers that are polypropylene fibers.

18. The wipe of claim 17, wherein the polypropylene fibers include from about 0.5% to about 5% TiO₂ by weight.

19. The wipe of claim 17, wherein the polypropylene fibers comprise from about 35% to about 70% by weight of the overall nonwoven substrate fibers included in the nonwoven substrate.

20. The wipe of claim 17, wherein the natural fibers comprise pulp fibers, the pulp fibers being present at from about 30% to about 65% by weight of the overall nonwoven substrate fibers included in the nonwoven substrate.
